(19) United States
(12) Patent Application Publication
(10) Pub. No.: US 2025/0304305 A1
(43) Pub. Date: Oct. 2, 2025

(54) VACUUM CYLINDER UNIT FOR TRANSFERRING LABELS

(71) Applicant: KRONES AG, Neutraubling (DE)

(72) Inventor: Michael SCHMID, Regensburg (DE)

(21) Appl. No.: 18/864,393

(22) PCT Filed: Mar. 22, 2023
(86) PCT No.: PCT/EP2023/057285

§ 371 Date: Nov. 8, 2024

(30) Foreign Application Priority Data
May 11, 2022 (DE) 10 2022 111 778.2

(51) Int. Cl. B65C 9/18

(52) U.S. Cl. CPC B65C 9/188

(57) ABSTRACT

The invention relates to a vacuum cylinder unit for transferring labels to containers in a vacuum-supported manner, and a labeling apparatus equipped with said unit. The vacuum cylinder unit comprises a stationary lower part, a drive shaft surrounded thereby, and a vacuum cylinder drive which is coupled thereto in a centered and entrained manner by a zero-point clamping system. Since the zero-point clamping system comprises a clamping pin integrated into the vacuum cylinder and a clamping chuck rigidly connected to the drive shaft and having a pneumatically openable locking mechanism for securely clamping the clamping pin, and since sealing rings, arranged in the lower part, can be inflated for sealing off an annular gap between the drive shaft and the lower part, in order to form between the sealing rings a ring duct for supplying compressed air to the locking mechanism, the vacuum cylinder can be raised.

### CROSS REFERENCE TO RELATED APPLICATIONS

The present application is a U.S. National Phase of International Application No. PCT/EP2023/057285 entitled “VACUUM CYLINDER UNIT FOR TRANSFERRING LABELS,” and filed on Mar. 22, 2023. International Application No. PCT/EP2023/057285 claims priority to German Patent Application No. 10 2022 111 778.2 filed on May 11, 2022. The entire contents of each of the above-listed applications are hereby incorporated by reference for all purposes.

### TECHNICAL FIELD

The invention relates to a vacuum cylinder unit according to the preamble of claim 1, and to a labeling apparatus, equipped with said unit, for labeling containers.

### BACKGROUND AND SUMMARY

Vacuum cylinder units are known components of labeling units for applying labels provided on rolls to containers, such as bottles, by hot-melt adhesive. The vacuum cylinder has the task here of transporting the labels provided with adhesive to the transport path of the containers in a vacuum-supported manner and transferring them to said containers.

The vacuum cylinder is matched to the labels in a format-specific manner and for format change can be pulled off upwards from the associated rotary drive. With regard to a torque transmission and good concentricity accuracy, a combination of a drive shaft with a polygonal cross-section and a correspondingly positive-locking hub on the vacuum cylinder has proven effective for this purpose. The polygonal shaft then extends substantially over the entire height of the vacuum cylinder, so that it has to be lifted off over the entire length of the polygonal connection during the format change and thus has to be pulled from the drive shaft. Due to the relatively high weight of the vacuum cylinder and the generally restricted access during changeover work, this procedure is very unfavorable from an ergonomic point of view.

As a remedy, generic vacuum cylinder units have been proposed, e.g., in DE 10 2011 090 190 A1, DE 10 2013 212 132 A1, and DE 20 2013 103 475 U1, in which the polygonal shaft is replaced by a self-centering connection of a clamping pin to a clamping chuck. Such connections are also referred to as zero-point clamping systems. In the generic apparatuses, the drive shaft has for this purpose a comparatively short shaft stub at its upper end, and the associated vacuum cylinder has a suitable clamping chuck which can be locked in a centering manner on the shaft stub.

It is true that, to remove the vacuum cylinder, the distance to be overcome manually during the format change can thereby be reduced compared to apparatuses having polygonal shafts. However, the clamping chuck and the associated actuating mechanism increase the weight of the vacuum cylinder, thereby partially nullifying the ergonomic advantages in the lifting of the vacuum cylinder. In addition, the clamping chuck and the associated actuating mechanism increase the amount of equipment needed for the vacuum cylinder conceived as an interchangeable part, which increases the cost of its purchase to an undesired extent.

The zero-point clamping systems of the generic vacuum cylinder units have therefore not yet become established, so that there is still a need to improve the ergonomics in the replacement of vacuum cylinders and thereby also to minimize as far as possible the costs for vacuum cylinders available in a format-specific manner.

The stated object is achieved with a vacuum cylinder unit according to claim 1. Accordingly, said vacuum cylinder unit is used to transfer labels in a vacuum-supported manner in a labeling apparatus for containers and comprises a stationary lower part, a drive shaft surrounded in a ring by the stationary lower part, and a vacuum cylinder which is coupled to the drive shaft in a centered and entrained manner by a zero-point clamping system.

According to the invention, the zero-point clamping system comprises a clamping pin integrated into the vacuum cylinder and a clamping chuck, rigidly connected to the drive shaft, having a locking mechanism which can be pneumatically opened by applying compressed air for securing the clamping pin. Furthermore, in the lower part, elastically inflatable sealing rings are arranged, which can be inflated using compressed air in order to seal off an annular gap between the drive shaft and the lower part upwards and downwards and thereby form a ring duct between the sealing rings to supply compressed air to the locking mechanism.

The sealing rings are formed as radial seals, which elastically expand inwards when inflated and thus provide a tight seal against the drive shaft.

The clamping pin is the passive component in the zero-point clamping system, and the clamping chuck is the actively closing/opening component. All components to be actuated for opening/closing the zero-point clamping system can thus be moved into the region of the drive shaft that is not to be replaced during the format change. Consequently, the comparatively heavy and expensive clamping chuck with the associated actuating elements does not have to be lifted/replaced when the vacuum cylinder is being replaced, so that the ergonomics are improved, and a comparatively favorable construction of the vacuum cylinder becomes possible.

In other words, the clamping pin arranged on the replaceable vacuum cylinder is comparatively lightweight and cost-effective.

Suitable zero-point clamping systems are known, for example, under the name “Zero Clamp®” and generally comprise a clamping chuck housing made of hardened stainless steel, a steel cone for play-free clamping of the associated pin, an associated precision radial spring, a spring leaf, and preferably a locking mechanism, which closes by spring force and can be pneumatically opened.

In addition, the ring duct temporarily created to open the zero-point clamping system allows the vacuum cylinder to be replaced in any rotational position. The arrangement of the sealing rings in the stationary lower part allows easy compressed air supply to them and to the ring duct.

Preferably, the sealing rings are formed and arranged such that they do not touch the drive shaft without the application of compressed air. This avoids unwanted frictional contact between the seals and the drive shaft during production.

Preferably, in the lower part, inwardly open grooves are formed to accommodate the sealing rings. Preferably, the unpressurized, relaxed sealing rings are then completely recessed into the grooves.

Preferably, the sealing rings are elastically deformable not only towards the drive shaft, but also on their outer circumference and, when relaxed without pressure, have an oversize of 0.1 to 3%, in particular of 0.5 to 1%, with respect to their circumference, in relation to a groove bottom formed in the grooves in the sense of a sealing seat. The sealing rings are then always under some tension in the groove, which means that the sealing rings reliably retract into the groove after venting.

Preferably, the sealing rings have a profile with an external clamping foot. Furthermore, in the region of a groove bottom formed in each of the grooves, a corresponding anchoring profile for the positive and/or non-positive radial anchoring of the clamping foot is then formed. The anchoring profile can, for example, be a C-profile or a T-profile or a shaped groove produced, for example, as a negative to match the clamping foot. This type of fastening is comparatively flexible, space-saving, and reliable.

Preferably, axially guided and detachable bolts for radial locking of the sealing rings are arranged in the stationary lower part in the region of a groove bottom formed in each of the grooves. This fastening variant is particularly suitable if the sealing rings are to be removed from the groove bottom for cleaning, for example, or to simplify the replacement of worn sealing rings, thereby reducing the downtime of the machine.

Preferably, the sealing rings are radially fixedly bonded to a groove bottom formed in each of the grooves. The seal is then, using a suitable adhesive, fixed exclusively in the groove bottom, which in this way is particularly reliable and provides high load carrying capacity.

Preferably, the following are also formed in the lower part: at least one first supply duct, opening between the grooves, for supplying compressed air to the ring duct; and second supply ducts, opening into the grooves, for supplying compressed air to the sealing rings. This allows for a seal seat with an easy-to-guide, stationary compressed air supply.

Preferably, separate, external compressed air connections are assigned to the first supply duct on the one hand and to the second supply ducts on the other. This allows separate and time-coordinated pressurization of compressed air first to the sealing rings and then to the clamping chuck, as well as pressure relief in the reverse order.

Preferably, the lower part is a ring-shaped component made substantially of plastic and produced by 3-D printing. This allows grooves and supply ducts with comparatively complex cross-sections and courses to be formed in the lower part in a manner which can be flexibly optimized in terms of construction. Furthermore, cost-effective production is possible.

Preferably, at least one and in particular each of the grooves has a cross-section which narrows from the groove bottom to the ring duct. This promotes automatic retraction of the unpressurized sealing rings into the grooves to avoid frictional contact with the drive shaft. The sealing rings can then have an outer cross-section which widens towards the bottom of the groove. For example, corresponding trapezoidal cross-sections of the sealing ring and the associated groove are conceivable.

The clamping chuck preferably comprises a spring-pretensioned locking mechanism which can be pneumatically opened, i.e., by applying compressed air. The spring force keeps the connection reliably closed even in the absence/failure of the compressed air supply. This means that the clamping pin is inserted into the clamping chuck when compressed air is applied, and the force-locking connection is produced by interrupting the supply of compressed air and is thus mechanically held until the compressed air is applied again. An ergonomic opening is thus provided by temporary compressed air supply when the vacuum cylinder is at a standstill.

Preferably, the clamping chuck is formed so as to be opened by application of compressed air at a pressure of 4 to 8 bar. This allows comparatively simple and ergonomic opening of the zero-point clamping system by means of a conventional, central compressed air supply.

Preferably, the clamping pin has an engagement length of 10 to 50 mm relative to the clamping chuck. This means that the engagement length has to be overcome with a manual stroke when the vacuum cylinder is being lifted from the drive. A relatively ergonomic removal of the vacuum cylinder is thus provided.

The stated object is also achieved by a labeling apparatus according to claim 13 and by a labeling apparatus according to claim 15. The labeling apparatus serves by definition for labeling containers, in particular bottles, and for this purpose comprises a vacuum cylinder unit, arranged for the direct transfer of labels to the containers, according to at least one of the described embodiments. The labeling apparatus is formed, for example, for the all-round labeling of the containers by labels provided from the roll and then coated with hot-melt adhesive. The labeling apparatus is then a hot-adhesive labeling unit. However, it can also be a cold-adhesive labeling assembly for containers.

The labeling machine comprises the described labeling apparatus and a continuously rotatable container carousel for positioning the containers during the label transfer.

### BRIEF DESCRIPTION OF THE FIGURES

A preferred embodiment of the invention is illustrated in the drawing. In the figures:

FIG. 1 shows a section through the vacuum cylinder unit;

FIG. 2 shows a partial region of the vacuum cylinder unit when the sealing rings are relaxed;

FIG. 3 shows a partial region of the vacuum cylinder unit when the sealing rings are inflated;

FIG. 4 shows the arrangement according to FIG. 3 in a different sectional plane;

FIG. 5 is an oblique view of the stationary lower part;

FIG. 6 is an oblique view of the drive assembly of the vacuum cylinder unit; and

FIG. 7 is a schematic plan view of a labeling machine with the vacuum cylinder unit.

### DETAILED DESCRIPTION

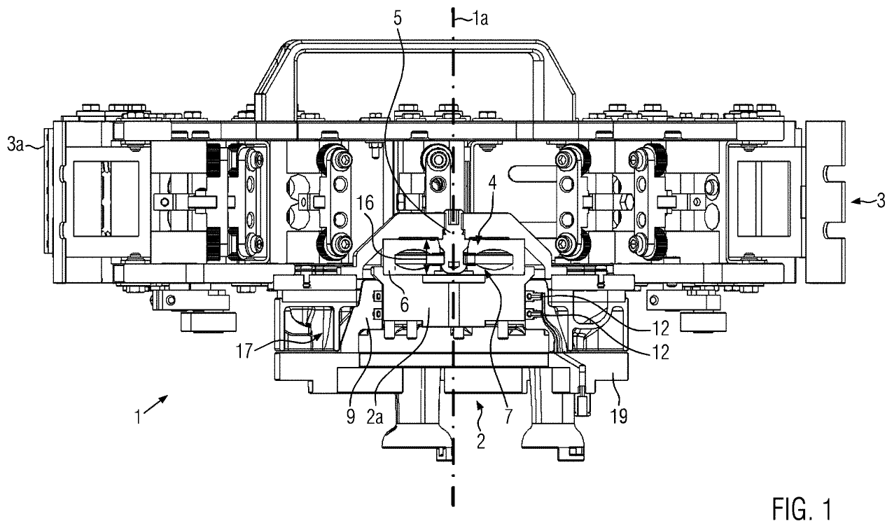

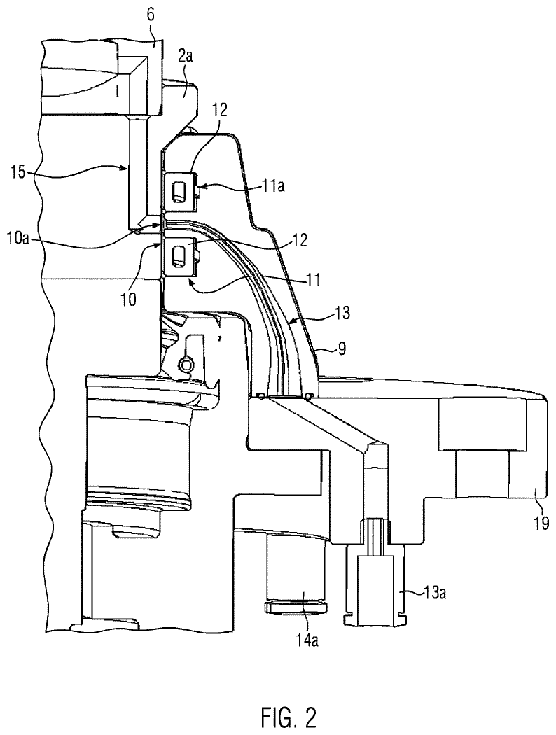

As can be seen, for example, in FIGS. 1 and 2, in a preferred embodiment, the vacuum cylinder unit 1 comprises a drive shaft 2 (having an adapter 2a comprised thereof) and a vacuum cylinder 3, which are centered with respect to an upright axis of rotation 1a by a zero-point clamping system 4 and are coupled to one another so as to transmit torque.

The zero-point clamping system 4 comprises a clamping pin 5, which is fastened to the vacuum cylinder 3 and which points downwards during working operation, and a clamping chuck 6, which is rigidly connected to the drive shaft 2, for securing the clamping pin 5 by gripping it.

The connection between the drive shaft 2 and the clamping chuck 6 is established, for example, by an adapter 2a which is arranged at the end of the drive shaft 2 and which, for the sake of simplicity, is considered to be a component of the drive shaft 2.

The clamping chuck 6 comprises a spring-pretensioned locking mechanism 7 which can be pneumatically opened by applying the first compressed air 8a (FIG. 3), as is known, for example, from the “Zero Clamp®” system.

The vacuum cylinder unit 1 further comprises a stationary lower part 9 which surrounds the drive shaft 2 in a ring shape. An annular gap 10 is formed (FIG. 2) between the drive shaft 2 rotating during working operation or the adapter 2a and the stationary lower part 9.

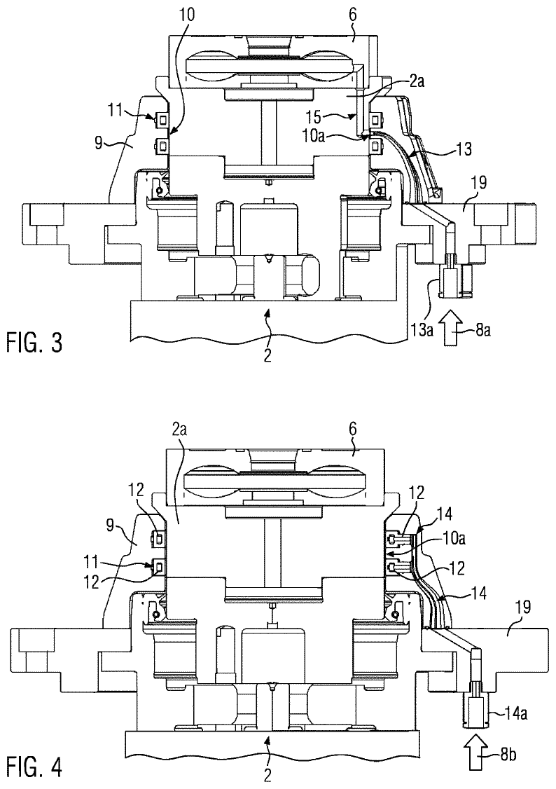

The lower part 9 comprises two inwardly open grooves 11, in each of which sits an elastically inflatable sealing ring 12. By applying a second compressed air 8b (FIG. 4), the sealing rings 12 can be inflated in order to seal off a portion, located between the sealing rings 12, of the annular gap 10 upwards and downwards and thereby temporarily form a ring duct 10a on the clamping chuck 6 for the first compressed air 8a required to open the locking mechanism 7. The terms “first” and “second” do not specify an order, but merely serve as a functional assignment.

The (pneumatically) unpressurized, relaxed sealing rings 12 are preferably completely countersunk into the grooves 11.

FIG. 2 shows the annular gap 10 during working operation of the vacuum cylinder 3 with relaxed/unpressurized sealing rings 12, whereas FIGS. 3 and 4 show the vacuum cylinder 3 at a standstill with inflated sealing rings 12 and the ring duct 10a temporarily formed in-between.

The ring duct 10a is created temporarily only when the vacuum cylinder 3 is at a standstill and is then completely delimited by the sealing rings 12, the drive shaft 2, or the adapter 2a and the lower part 9. This makes it possible to supply compressed air to the clamping chuck 6 regardless of the rotational position of the vacuum cylinder 3.

As can be seen in FIG. 2, the sealing rings 12 are anchored in the grooves 11 in such a way that they do not touch the drive shaft 2 without application of the second compressed air 8b to the seals 12. This prevents undesirable frictional contact between the seals 12 during working operation.

For this purpose, the sealing rings 12 can be bonded and/or mechanically fastened, for example, to the groove bottom 11a (on the outwardly facing wall region) of the grooves 11, in particular (non-destructively) releasably by positive-locking and/or force-locking clamping and/or by a bolt lock (not shown), as already described above.

Additionally or alternatively, the sealing rings 12 in the unpressurized relaxed state can have a circumferential oversize with respect to the associated groove bottoms 11a—for example, of 0.1 to 3% and in particular of 0.5 to 1% (not shown). As a result, the sealing rings 12 are compressed circumferentially even in the unpressurized state and avoid the tension generated thereby by migrating back to the groove bottom 11a if necessary and then remaining there, so that they are reliably arranged at a distance from the drive shaft 2/the adapter 2a during working operation, and frictional contact is thus avoided.

Additionally or alternatively, the grooves 11 could have a cross-section (not shown) that narrows inwards at least in portions from the groove bottom 11a. For example, the grooves 11 and the sealing rings 12 could have trapezoidal cross-sections tapering towards the annular gap 10.

The aforementioned measures ensure that the unpressurized, relaxing sealing rings 12 retract reliably into the grooves 11 so that they are subsequently held at a distance from the drive shaft 2 rotating during operation/from the adapter 2a.

In order to supply the ring duct 10a with the first compressed air 8a from the outside, at least one first supply duct 13 is formed in the stationary lower part 9.

To supply the sealing rings 12 with the second compressed air 8b from outside, second supply ducts 14 are formed in the stationary lower part 9.

In addition, in the drive shaft 2 or in the adapter 2a, at least one connecting duct 15, e.g., in the form of a bore, is formed which opens into the annular gap 10 at the level of the temporary ring duct 10a and leads to the clamping chuck 6 of the locking mechanism 7.

After the sealing rings 12 are inflated by applying the second compressed air 8b, the first compressed air 8a can thus be applied to the clamping chuck 6 through the first supply duct 13, the temporary ring channel 10a, and the connecting line 15 in order to pneumatically open the locking mechanism 7 so that the vacuum cylinder 3 can be removed as a result of the clamping pin 5 being released.

The grooves 11 and the sealing rings 12 are fully formed to allow application to the clamping chuck 6 of the first compressed air 8a regardless of the rotational position of the vacuum cylinder 3 with respect to the lower part 9. That is to say, the vacuum cylinder 3 can be pulled off upwards in any rotational position relative to the lower part 9 with a suitable application of compressed air to the clamping chuck 6. This allows ergonomic handling of the vacuum cylinder 3 during format-specific replacement.

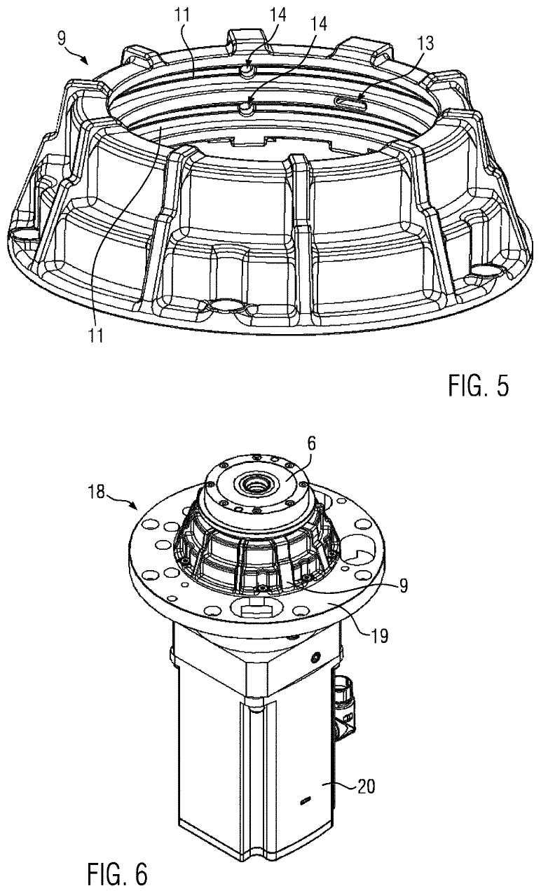

The stationary lower part 9 is preferably a ring-shaped component which is produced, for example, in a 3-D printing process in a manner known in principle. As FIG. 5 shows by way of example, the grooves 11 and the supply ducts 13, 14 can thus be produced with a comparatively complex shape and optimized in a particularly practical manner.

The first compressed air 8a can be supplied from the outside, for example, via an inlet-side compressed air connection 13a of the first supply line 13, and the second compressed air 8b can be supplied via a separate compressed air connection 14a to the second supply lines 14; see, for example, FIGS. 3 and 4.

The first and second compressed air 8a, 8b can then be mechanically switched on separately from one another in a manner known in principle.

The first and second compressed air 8a, 8b can be provided in a manner known in principle with different pressure levels or can also have identical pressure levels.

In particular, the first compressed air 8a can also be provided via a hose with an air pressure gun or similar valve as a result of manual activation.

Indexing pins and/or indexing holes surrounding the clamping pin 5 can be present (not shown) in the region of the zero-point clamping system 4, e.g., on the vacuum cylinder 3, in order to fix the rotational position of the vacuum cylinder 3 relative to the drive shaft 2. In the region of the clamping chuck 6, corresponding openings and/or pins are thereby provided. Such indexing can then serve not only to fix the relative rotational positions relative to one another; rather, the torque transmission from the drive shaft 2 to the vacuum cylinder 3 is supplemented by the zero-point clamping system 4, i.e., the force-fitting connection between the clamping pin 5 and the clamping chuck 6.

The indexing pins and associated holes can be embedded in the clamping chuck 6 and in an adapter for the clamping pin 5 and can be based upon a conventional anti-twisting device for other uses of such clamping chucks. In a manner known in principle, visual, optoelectronic, contact-electrical control, and/or vacuum sensing are possible to ensure correct engagement of the vacuum cylinder 3.

The zero-point clamping system 4 preferably automatically closes by spring pretensioning, but could in principle additionally be tightened mechanically. For separating and putting together the zero-point clamping system 4, said system is pneumatically opened—for example, by applying the first compressed air 8a with an air pressure of 4 to 8 bar to the temporary ring duct 10a. By pressure relief, the zero-point clamping system 4 locks in a centering and force-fitting manner by itself and remains permanently locked without the renewed application of pressure.

The clamping pin 5 preferably has an engagement length 16—to be overcome during lifting of the vacuum cylinder 3—of at most 50 mm into the clamping chuck 6 in order to allow ergonomic replacement of the vacuum cylinder 3.

For the sake of completeness, it should also be mentioned that suction elements 3a known in principle on the vacuum cylinder 3 are arranged so as to be uniformly distributed for receiving/dispensing labels. An associated vacuum distribution ring 17 surrounds the stationary lower part 9; see FIG. 1. The vacuum distribution ring 17 is pressed against a corresponding sealing surface of the vacuum cylinder 3 by compression springs in order to allow its vacuum supply. Vacuum can then be supplied to the suction elements 3a in a manner known in principle via pneumatic connections and hoses (not shown).

FIG. 6 shows, by way of example, the clamping chuck 6 and the lower part 9 as components of a drive group 18 for the vacuum cylinder 3 with a stationary support plate 19 (see, for example, also FIGS. 2 to 4) and a drive motor 20.

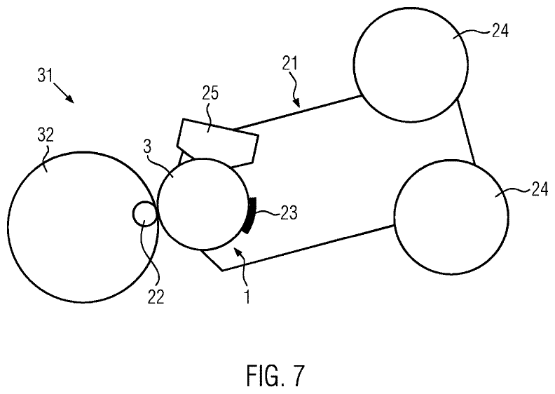

FIG. 7 shows, by way of example and schematically, a labeling apparatus 21 for labeling containers 22 (only one shown), in particular bottles, with the vacuum cylinder unit 1, with an exchangeable vacuum cylinder 3, arranged for the direct transfer of labels 23 (only one shown) to the containers 22.

The labels 23 are provided, for example, from rolls 24 and coated by a gluing unit 25 with hot-melt adhesive. The labeling apparatus 21 shown is thus preferably a hot-adhesive labeling assembly.

Alternatively, a corresponding coupling of a vacuum cylinder unit 1 would also be conceivable in the case of a cold-adhesive labeling assembly (not shown), and/or in the case of gripper cylinders, transfer cylinders, or similar rotating units which would have to be replaced in their entirety on labeling apparatuses, depending upon the format.

The labeling apparatus 21 is then preferably a component of a labeling machine 31, which comprises a continuously rotatable container carousel 32 for positioning the containers 22 during the label transfer, and at least one labeling apparatus 21 docked in a manner known in principle at the periphery of the container carousel 32.

The described arrangement of the zero-point clamping system 4 with clamping pin 5 arranged on the vacuum cylinder 3 and with clamping chuck 6 arranged on the drive shaft 2 enables an ergonomic replacement of the vacuum cylinder 3 in the event of format changes and also reduces the costs for the individual vacuum cylinders 3 to be kept available in a format- specific manner.

The temporary ring channel 10a also allows the vacuum cylinder 3 to be replaced regardless of its rotational position.

For the exchange of the vacuum cylinder 3, the motor connected to the drive shaft 2 is switched off, and the vacuum cylinder unit 1 is brought to a standstill, i.e., without a running rotary drive.

As soon as the vacuum cylinder 3 no longer rotates, the second compressed air 8b can be switched on—for example, at the external compressed air connection 13a. As a result, the sealing rings 12 are inflated, and the ring duct 10a is temporarily formed in the annular gap 10. The first compressed air 8a can then be switched on and applied via the ring channel 10a to the clamping chuck 6, causing this to open in such a way that the clamping pin 5 is released, and the vacuum cylinder 3 can be lifted upwards from the drive shaft 2.

While the first and second compressed air 8a, 8b continues to be applied, a suitable vacuum cylinder 3 can be set in place for another label format by inserting its clamping pin 5 into the clamping chuck 6.

The clamping pin 5, by switching off the first compressed air 8a and ventilating the ring duct 10a, is then mechanically clamped in the clamping chuck 6 by spring pretensioning said clamping chuck and is thus locked in a torsionally rigid manner. Indexing pins, which otherwise serve to prevent rotation when the clamping chuck 6 is used individually, can support torque transmission here.

That is to say, when the clamping pin 5 is inserted into the clamping chuck 6, it is acted upon with the first compressed air 8a and thus opened. By switching off the supply of compressed air and ventilating the ring duct 10a, the clamping chuck 6 automatically closes around the clamping pin 5 by spring pretensioning.

Subsequently, the second compressed air 8b can also be switched off so that the sealing rings 12 are ventilated, relax, and retract back into their grooves 11.

For the correct assignment of the rotational position of the vacuum cylinder 3 to the drive shaft 2, indexing pins and/or indexing holes present on the vacuum cylinder 3 are preferably brought into engagement with corresponding structures in the region of the clamping chuck 6. The torque required during working operation is then predominantly transferred by the force-fit of the zero-point clamping system 4 from the drive shaft 2 to the vacuum cylinder 3—for example, via the adapter 2a.

The absolute rotational position of the drive shaft 2/of the clamping chuck 6 can thereby be freely selected thanks to the pressure coupling over the full circumference through the temporarily formed ring duct 10a.

After the zero-point clamping system 4 is closed by switching off the supply of the first as well as the second compressed air 8a, 8b, the vacuum cylinder unit 1 and the labeling apparatus 21/labeling machine 31 associated therewith can resume working operation.

1. A vacuum cylinder unit for transferring labels in a vacuum-supported manner in a labeling apparatus for containers, having a stationary lower part, a drive shaft surrounded in a ring by the lower part, and a vacuum cylinder which is coupled to the drive shaft in a centered and entrained manner by a zero-point clamping system, wherein the zero-point clamping system comprises a clamping pin integrated into the vacuum cylinder and a clamping chuck rigidly connected to the drive shaft and having a pneumatically openable locking mechanism for securely clamping the clamping pin, and in that sealing rings, arranged in the lower part, can be inflated for sealing off an annular gap between the drive shaft and the lower part in order to form between the sealing rings a ring duct for supplying compressed air to the locking mechanism.

2. The vacuum cylinder unit according to claim 1, wherein inwardly open grooves for receiving the sealing rings are formed in the lower part, and wherein the sealing rings are formed and arranged such that they do not touch the drive shaft without the application of compressed air.

3. The vacuum cylinder unit according to claim 2, wherein the sealing rings are also elastically deformable on their outer circumference and have a circumferential oversize of 0.1 to 3%, with respect to a groove bottom formed in each of the grooves.

4. The vacuum cylinder unit according to claim 2, wherein the sealing rings have a profile having an external clamping foot, and wherein a corresponding anchoring profile for the positive-locking and/or force-locking radial anchoring of the clamping foot is formed in the region of a groove bottom formed in each of the grooves.

5. The vacuum cylinder unit according to claim 2, wherein axially detachable bolts for radially locking the sealing rings are arranged in the region of a groove bottom formed in each of the grooves.

6. The vacuum cylinder unit according to claim 2, wherein the sealing rings are radially fixedly bonded to a groove bottom formed in each of the grooves.

7. The vacuum cylinder unit according to claim 2, wherein at least one of the grooves has a cross-section narrowing from the respective groove bottom to the ring duct.

8. The vacuum cylinder unit according to claim 2, wherein at least one first supply duct, opening between the grooves, for supplying compressed air into the ring duct and second supply ducts, opening into the grooves, for supplying compressed air to the sealing rings are formed in the lower part.

9. The vacuum cylinder unit according to claim 1, wherein the lower part is a ring-shaped plastic component produced by 3-D printing.

10. The vacuum cylinder unit according to claim 1, wherein the locking mechanism of the clamping chuck is formed so as to close by spring pretensioning.

11. The vacuum cylinder unit according to claim 1, wherein the clamping chuck is formed for pneumatic opening of the zero-point clamping system by application of compressed air at a pressure of 4 to 8 bar.

12. The vacuum cylinder unit according to claim 1, wherein the clamping pin has an engagement length of 10 to 50 mm relative to the clamping chuck.

13. A labeling apparatus for containers, having a vacuum cylinder unit according to claim 1, which is arranged for directly transferring labels to the containers.

14. The labeling apparatus according to claim 13, which is formed to transfer labels provided on rolls and coated with hot-melt adhesive.

15. A labeling machine having the labeling apparatus according to claim 13 and having a continuously rotatable container carousel for positioning the containers during the label transfer.

16. The vacuum cylinder unit according to claim 8, wherein the first supply duct on the one hand and the second supply ducts on the other are assigned separate, external compressed air connections.

17. The vacuum cylinder unit according to claim 1, wherein the containers are bottles.
